(19) United States
(12) Patent Application Publication
(10) Pub. No.: US 2023/0251101 A1
(43) Pub. Date: Aug. 10, 2023

(54) ROUTE GUIDANCE METHOD

(71) Applicant: TOYOTA JIDOSHA KABUSHIKI KAISHA, Toyota-shi Aichi-ken (JP)

(72) Inventors: Taizo Masuda, Yokohama-shi Kanagawa-ken (JP); Ryota Tomizawa, Mishima-shi Shizuoka-ken (JP); Sei Miyazaki, Susono-shi Shizuoka-ken (JP); Yuki Nishikawa, Susono-shi Shizuoka-ken (JP)

(73) Assignee: TOYOTA JIDOSHA KABUSHIKI KAISHA, Toyota-shi Aichi-ken (JP)

(21) Appl. No.: 17/989,140

(22) Filed: Nov. 17, 2022

(30) Foreign Application Priority Data
Feb. 10, 2022 (JP) 2022-019484

(51) Int. Cl. G01C 21/34

(52) U.S. Cl. CPC G01C 21/3484; G01C 21/3415

(57) ABSTRACT

A route guidance method for providing a pedestrian route to a user includes: a determination step of determining whether the user is a visually impaired person; a first acquisition step of, when the user is determined to be a visually impaired person, acquiring first position information indicative of a position of a visually impaired person guidance block present on the pedestrian route from map information including information on the visually impaired person guidance block; a second acquisition step of acquiring second position information indicative of a position of an obstruction to use of the visually impaired person guidance block; and a notification step of, when at least part of the position indicated by the first position information is included in the position indicated by the second position information, notifying the user that there is an obstruction to the use of the visually impaired person guidance block.

### CROSS-REFERENCE TO RELATED APPLICATION

This application claims priority to Japanese Patent Application No. 2022-019484 filed on Feb. 10, 2022, incorporated herein by reference in its entirety.

### BACKGROUND

### 1. Technical Field

The present disclosure relates to a technical field of a route guidance method for providing a pedestrian route, for example.

### 2. Description of Related Art

As a method of this type, a method for providing a pedestrian route via a terminal device possessed by a user by specifying the pedestrian route based on a request from the user and map information has been proposed (see Japanese Unexamined Patent Application Publication No. 2020-165710 (JP 2020-165710 A)).

### SUMMARY

In the technology described in JP 2020-165710 A, in a case where the user is a visually impaired person, a pedestrian route is calculated based on sidewalk information and facility information included in the map information such that a suitability degree becomes higher as the installation rate of a visually impaired person guidance block (hereinafter referred to as a “braille block” appropriately) or a traffic light equipped with an acoustic system is higher. However, due to presence of an obstacle such as an illegally parked bicycle on the braille block, for example, or due to a sidewalk being under construction, for example, the braille block might become unusable temporarily. Information on such an obstacle or construction is not reflected on the map information. This point is not taken into consideration in the technology described in JP 2020-165710 A, and there is room for improvement.

The present disclosure is accomplished in view of the above problem, for example, and an object of the present disclosure is to provide a route guidance method that can notify a visually impaired person that there is an obstruction to the use of a braille block.

A route guidance method according to one aspect of the disclosure is a route guidance method for providing a pedestrian route to a user. The route guidance method includes: a determination step of determining whether the user is a visually impaired person or not; a first acquisition step of, in a case where the user is determined to be a visually impaired person, acquiring first position information indicative of a position of a visually impaired person guidance block present on the pedestrian route from map information including information on the visually impaired person guidance block; a second acquisition step of acquiring second position information indicative of a position of an obstruction to use of the visually impaired person guidance block; and a notification step of, in a case where at least part of the position indicated by the first position information is included in the position indicated by the second position information, notifying the user that there is an obstruction to the use of the visually impaired person guidance block.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating a route guidance system according to an embodiment; and

FIG. 2 is a flowchart illustrating the operation of the route guidance system according to the embodiment.

### DETAILED DESCRIPTION OF EMBODIMENTS

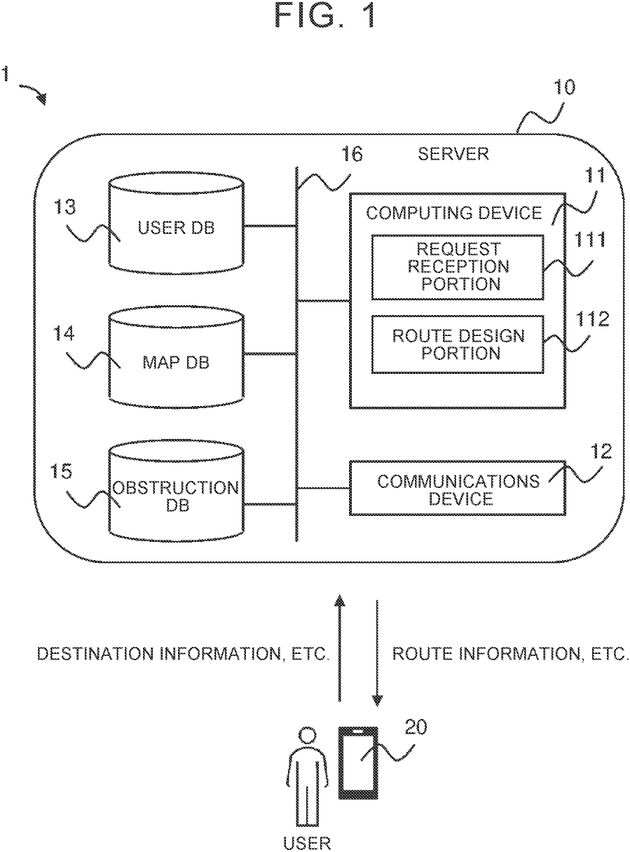

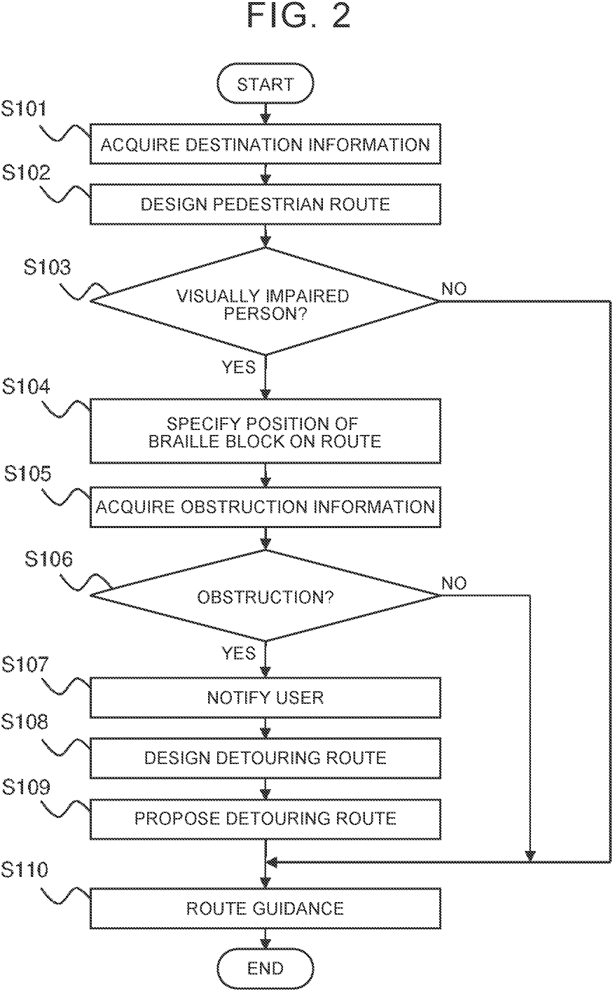

An embodiment according to a route guidance method will be described with reference to FIGS. 1, 2. In FIG. 1, the route guidance system 1 includes a server 10, and a terminal device 20 possessed by a user. The server 10 and the terminal device 20 are communicable with each other via a wide area network such as the Internet, for example.

An application to use the route guidance system 1 is installed in the terminal device 20. In other words, the terminal device 20 is configured to execute the application to use the route guidance system 1. The terminal device 20 may be a smartphone, a tablet terminal, a laptop personal computer, or the like.

The server 10 includes a computing device 11, a communications device 12, a user database 13 (hereinafter referred to as a “user DB 13”), a map database 14 (hereinafter referred to as a “map DB 14”), and an obstruction database 15 (hereinafter referred to as an “obstruction DB 15”). The computing device 11, the communications device 12, the user DB 13, the map DB 14, and the obstruction DB 15 are connected to each other via a bus 16.

The user DB 13 includes information on a user of the route guidance system 1. The information on the user may include, for example, full name, contact information (telephone number, e-mail address, address, and the like), sex, age, and the like. In the present embodiment, the information on the user particularly includes information indicative of whether the user is a visually impaired person or not.

The map DB 14 includes a relatively high-definition map. The relatively high-definition map includes braille block information on a braille block. The braille block information includes information indicative of a position where a braille block is provided, information indicative of the type of the braille block (guidance, warning, or the like), and so on. The obstruction DB 15 includes obstruction information indicative of an obstruction to the braille block. The obstruction information may include the type of the obstruction, the position of the obstruction, date and time, and so on.

The type of the obstruction is, for example, abnormality, construction, obstacle, and the like. The “abnormality” indicates that there is some sort of problem with the braille block itself, e.g., breakage, detachment, or the like of the braille block, for example. The “obstacle” indicates that an object such an illegally parked bicycle is present on the braille block, for example. The obstruction information may be acquired based on information (construction plan information, or the like) announced by a government office, a private sector, or the like, for example, or may be acquired by analyzing so-called big data such as information collected from so-called connected cars or information collected from social networking service (SNS), for example.

In a case where the user uses the route guidance system 1, the user inputs, via the terminal device 20, starting point information indicative of a starting point of a route the guidance of which the user desires and end point information indicative of an end point of the route. The user indicates his or her intention, for example, by pressing a predetermined button such as “ROUTE SEARCH” or “ROUTE GUIDANCE” displayed on a screen of the terminal device 20 (that is, the user requests route guidance to the route guidance system 1). At the time when the user indicates the intention, the starting point information and the end point information may be transmitted to the server 10. Note that the “end point of the route” may be called a “destination.”

Upon receipt of the request of route guidance from the user, the computing device 11 of the server 10 designs a route based on the starting point information and the end point information. The computing device 11 transmits route information indicative of a designed pedestrian route to the terminal device 20 via the communications device 12. After that, the terminal device 20 performs route guidance based on the route information. In order to design a pedestrian route, the computing device 11 includes a request reception portion 111 and a route design portion 112 as processing blocks logically implemented or processing circuits physically implemented inside the computing device 11.

The request reception portion 111 receives the request of route guidance from the user. At this time, the request reception portion 111 acquires the starting point information and the end point information from the terminal device 20 via the communications device 12. The starting point information and the end point information may be information indicative of coordinates on a map. In this case, the user may specify a starting point and an end point on the map displayed on the screen of the terminal device 20, for example. The user does not need to input the starting point information. In this case, the request reception portion 111 may consider the current position of the user to be the starting point. The current position of the user should be acquired from position information indicative of the position of the terminal device 20, for example.

In a case where the route guidance system 1 cooperates with other systems such as an vehicle allocation system or a boarding reservation system for a bus or a train, for example, the request reception portion 111 may consider a position (that is, a boarding position for the user) where a vehicle is allocated to be the end point based on vehicle allocation reservation information associated with the user who requests the route guidance, for example. In this case, the user does not need to input the end point information. Further, in a case where the request reception portion 111 receives the request of the route guidance when the user is in a vehicle, for example, the request reception portion 111 may consider a position where the user gets off from the vehicle to be the starting point based on the vehicle allocation reservation information associated with the user, for example. In this case, the user does not need to input the starting point information. The vehicle may be an autonomous driving vehicle.

The route design portion 112 designs a pedestrian route from the starting point indicated by the starting point information to the end point indicated by the end point information based on the starting point information and the end point information acquired by the request reception portion 111 and a map included in the map DB 14. At this time, the route design portion 112 determines whether the user who requests the route guidance is a visually impaired person or not, with reference to the user DB 13. In a case where the route design portion 112 determines that the user is a visually impaired person, the route design portion 112 extracts information on a braille block on the designed pedestrian route based on the braille block information included in the map DB 14.

The route design portion 112 further determines whether or not there is an obstruction to the use of the braille block on the designed pedestrian route, based on the designed pedestrian route, the extracted information on the braille block, and the obstruction DB 15. The route design portion 112 acquires the position of an obstruction indicated by the obstruction information included in the obstruction DB 15. In a case where at least part of the position of the braille block indicated by the extracted information on the braille block is included in the acquired position of the obstruction, the route design portion 112 determines that there is an obstruction to the use of the braille block.

In a case where the route design portion 112 determines that there is an obstruction to the use of the braille block, the route design portion 112 transmits, to the terminal device 20 via the communications device 12, route information indicative of the designed pedestrian route, and information indicative of the position of the obstruction to the use of the braille block. In this case, the terminal device 20 notifies the user that there is an obstruction to the use of the braille block. Note that the position of the obstruction to the use of the braille block may be specified based on the braille block information and the obstruction information.

In this case, the route design portion 112 designs a new pedestrian route (that is, a detour route) detouring around the position of the obstruction to the use of the braille block. The route design portion 112 transmits route information indicative of the new pedestrian route thus designed to the terminal device 20 via the communications device 12. That is, the route design portion 112 proposes a new pedestrian route to the user.

The operation of the route guidance system 1 will be described in more detail with reference to the flowchart of FIG. 2. In FIG. 2, the request reception portion 111 of the computing device 11 acquires starting point information and end point information (step S101). Based on the starting point information and the end point information acquired in the process of step S101 and the map DB 14, the route design portion 112 of the computing device 11 designs a pedestrian route from a starting point indicated by the starting point information to an end point (that is, a destination) indicated by the end point information (step S102).

Subsequently, with reference to the user DB 13, the route design portion 112 determines whether the user is a visually impaired person or not (step S103). In the process of step S103, in a case where the route design portion 112 determines that the user is not a visually impaired person (step S103: No), the route design portion 112 transmits route information indicative of the pedestrian route designed in the process of step S102 to the terminal device 20 via the communications device 12. The terminal device 20 provides route guidance to the user based on the received route information (step S110).

In the process of step S103, in a case where the route design portion 112 determines that the user is a visually impaired person (step S103: Yes), the route design portion 112 extracts information on a braille block on the pedestrian route designed in the process of step S102, based on the braille block information included in the map DB 14. The route design portion 112 specifies (acquires) the position of the braille block on the pedestrian route based on the extracted information (step S104).

The route design portion 112 further acquires the position of an obstruction indicated by the obstruction information included in the obstruction DB 15 (step S105). The route design portion 112 determines whether or not there is an obstruction to the use of the braille block, based on the position of the braille block specified in the process of step S104 and the position of the obstruction acquired in the process of step S105 (step S106).

In the process of step S106, in a case where the route design portion 112 determines that there is no obstruction to the use of the braille block (step S106: No), the route design portion 112 incorporates information indicative of the position of the braille block specified in the process of step S104 into the route information indicative of the pedestrian route designed in the process of step S102. The route design portion 112 transmits the route information to the terminal device 20 via the communications device 12. The terminal device 20 provides route guidance to the user based on the received route information (step S110). At this time, the terminal device 20 may notify the user of whether or not there is a braille block, the position of the braille block, or the like, for example.

In the process of step S106, in a case where the route design portion 112 determines that there is an obstruction to the use of the braille block (step S106: Yes), the route design portion 112 transmits, to the terminal device 20 via the communications device 12, the route information indicative of the pedestrian route designed in the process of step S102, and information indicative of the position of the obstruction to the use of the braille block. The terminal device 20 notifies the user that there is an obstruction to the use of the braille block (step S107).

The route design portion 112 designs a new pedestrian route (that is, a detour route) detouring around the position of the obstruction to the use of the braille block (step S108). The route design portion 112 transmits route information indicative of the new pedestrian route designed in the process of step S108 to the terminal device 20 via the communications device 12. The terminal device 20 proposes the new pedestrian route indicated by the route information to the user (step S109). Note that the route information indicative of the new pedestrian route includes information indicative of the position of a braille block on the new pedestrian route.

In a case where the user accepts the new pedestrian route proposed in the process of step S109, the terminal device 20 provides route guidance to the user based on the route information indicative of the new pedestrian route (step S110). Note that, in a case where the user does not accept the new pedestrian route proposed in the process of step S109, the route design portion 112 may design a pedestrian route again or may provide route guidance based on the route information indicative of the pedestrian route designed in the process of step S102 (that is, the pedestrian route with the obstruction to the use of the braille block).

### Technical Effect

With the route guidance system 1, it is possible to notify a visually impaired person as a user that there is an obstruction to the use of a braille block, as described above.

Various aspects of the disclosure to be achieved by the embodiment described above will be described below.

A route guidance method according to one aspect of the disclosure is a route guidance method for providing a pedestrian route to a user. The route guidance method includes: a determination step of determining whether the user is a visually impaired person or not; a first acquisition step of, in a case where the user is determined to be a visually impaired person, acquiring first position information indicative of a position of a visually impaired person guidance block present on the pedestrian route from map information including information on the visually impaired person guidance block; a second acquisition step of acquiring second position information indicative of a position of an obstruction to use of the visually impaired person guidance block; and a notification step of, in a case where at least part of the position indicated by the first position information is included in the position indicated by the second position information, notifying the user that there is an obstruction to the use of the visually impaired person guidance block.

In the above embodiment, for example, the “information indicative of the position of the braille block specified in the process of step S104” corresponds to an example of the “first position information,” and the “position of the obstruction acquired in the process of step S105” corresponds to an example of the “second position information.”

The route guidance method may include a proposal step of, in the case where at least part of the position indicated by the first position information is included in the position indicated by the second position information, proposing a new pedestrian route detouring around a position of the at least part of the position indicated by the first position information.

The present disclosure is not limited to the embodiment described above. The present disclosure is modifiable appropriately as far as the modification is not against the gist or idea of the disclosure that can be read from claims and the whole specification. A route guidance method based on such a modification is also included in the technical scope of the present disclosure.

What is claimed is:

1. A route guidance method for providing a pedestrian route to a user, the route guidance method comprising:
a determination step of determining whether the user is a visually impaired person or not;
a first acquisition step of, in a case where the user is determined to be a visually impaired person, acquiring first position information indicative of a position of a visually impaired person guidance block present on the pedestrian route from map information including information on the visually impaired person guidance block;
a second acquisition step of acquiring second position information indicative of a position of an obstruction to use of the visually impaired person guidance block; and
a notification step of, in a case where at least part of the position indicated by the first position information is included in the position indicated by the second position information, notifying the user that there is an obstruction to the use of the visually impaired person guidance block.

2. The route guidance method according to claim 1, comprising a proposal step of, in the case where at least part of the position indicated by the first position information is included in the position indicated by the second position information, proposing a new pedestrian route detouring around a position of the at least part of the position indicated by the first position information.
